(19) United States
(12) Patent Application Publication
(10) Pub. No.: US 2012/0232846 A1
(43) Pub. Date: Sep. 13, 2012

(54) INTELLIGENT DEVICE AND DATA NETWORK

(75) Inventors: Thomas Quinlan, Stow, MA (US); Paul J. Gaudet, Dracut, MA (US); Thomas P. Blackadar, Natick, MA (US); Norbert Ohlenbusch, Andover, MA (US)

(73) Assignee: FitSense Technology, Inc., Shelton, CT (US)

(21) Appl. No.: 13/480,169

(22) Filed: May 24, 2012

Related U.S. Application Data
(63) Continuation of application No. 11/799,033, filed on Apr. 30, 2007.
(60) Provisional application No. 60/795,763, filed on Apr. 28, 2006.
(60) Provisional application No. 60/813,846, filed on Jun. 15, 2006.

(51) Int. Cl. G06F 15/00

(52) U.S. Cl. 702/188

(57) ABSTRACT

A network for electronic communications in which disparate anonymous devices may transmit and receive information, such as in a secure manner. A method for collecting health-related data may, for example, comprise detecting, at a first time, that a sensor has moved within a detection range of a link component, the sensor having not been identified to the link component prior to the first time; receiving data collected by the sensor relating to activity by and/or health of a human subject associated with the sensor; and processing the data to determine at least one indicator of the human subject's health.

### RELATED APPLICATIONS

This application is a continuation of co-pending U.S. patent application Ser. No. 11/799,033, entitled “Intelligent Device And Data Network,” filed Apr. 30, 2007 and bearing Attorney Docket No. P0663.70028US01, which claims the benefit under 35 U.S.C. §119(e) of both U.S. Provisional Patent Application Ser. No. 60/795,763, filed Apr. 28, 2006, and U.S. Provisional Patent Application Ser. No. 60/813,846, filed Jun. 15, 2006. The entire contents of each of the preceding documents are incorporated herein by reference.

### FIELD

This invention relates generally to electronic communications, and more particularly to a network for electronic communications in which disparate anonymous devices may transmit and receive information, such as in a secure manner.

### BACKGROUND

Conventionally, in order for a device (e.g., cell phone, computer, PDA, scanner, etc.) to communicate via a network, the device must be identified and/or registered to the network. For example, ARP and DHCP procedures may be executed to assign the device an IP address on the network, or to otherwise register it before allowing it to transmit and receive data over the network.

Conventional network architectures have been employed to transmit health-related information from monitoring devices worn on a subject's body to a client component, which receives and stores the information to a database for analysis. In these conventional systems, the devices worn by the subject are authenticated to the network before transmission of information to the client component is allowed. Hence, anonymous devices are not capable of transmitting information via the network.

### SUMMARY

According to one aspect of the present invention, a method for collecting health-related data comprises acts of: (A) with a link component, detecting, at a first time, that a sensor has moved within a detection range of the link component, the sensor having not been identified to the link component prior to the first time; (B) with the link component, receiving data collected by the sensor relating to activity by and/or health of a human subject associated with the sensor; and (C) processing the data to determine at least one indicator of the human subject's health.

According to another aspect of the invention, a method for collecting and analyzing health-related data comprises acts of: (A) providing a link component which receives, at a first time, data collected and transmitted by a sensor, the data relating to activity by and/or health of a human subject, the sensor having not been identified to the link component prior to the first time; and (B) providing a processing component which processes data received by the link component to determine at least one indicator of the human subject's health.

According to yet another aspect of the invention, a system for collecting health-related data comprises a sensor, associated with a human subject, operable to collect and transmit data relating to activity by and/or health of the human subject; a link component operable to detect, at a first time, whether the sensor has been moved within a detection range of the link component and to receive data transmitted by the sensor when the sensor is within the detection range, the sensor having not been identified to the link component prior to the first time; and a processing component operable to process data received by the link component relating to activity by and/or health of the human subject to determine at least one indicator of the human subject's health.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings, in which like reference numerals represent like components:

FIG. 1 is a block diagram depicting communication between network nodes;

FIG. 2 is a block diagram depicting an exemplary implementation of a system to capture, store and analyze health-related information;

FIG. 3 is a block diagram depicting interaction between a sensor device and a client component;

FIG. 4 is an activity and block diagram depicting data transfer between a sensor device and a client component; and

FIG. 5 is a block diagram depicting various modules of a client component.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In one embodiment, a communications network includes disparate anonymous devices which are allowed to connect to, and transmit and receive information on, the network without being previously identified thereto. The network may, for example, comprise nodes including one or more disparate, anonymous devices (hereinafter “sensor devices”), a client component (which may be implemented in a cell phone, set top box, personal computer, game box, personal automobile computer, kiosk, or any other device suitably configured for communication on the network), a system server executing registration services and in communication with one or more data stores, and an application server which interacts with the system server and/or data store(s). In some embodiments, information transmitted by the sensor devices may be received by the client component, processed, forwarded to the system server for further processing and stored in a data store so that the information may be analyzed by the application server.

In some embodiments, a sensor device may communicate information via a radio frequency, and communication may occur when the sensor device is moved within a physical detection range of the client component. When this occurs, the client component may identify the sensor device. For example, the sensor device may transmit information which includes an identifying portion and a payload portion. The client component may process the identifying portion (which may include, as an example, a unique identifier given to the sensor device at the time of manufacture consisting of a manufacturer ID and system model number) to identify the sensor device. The information provided by the sensor device may thereafter be forwarded to the system server, which may compare the identifying portion to a global registry of sensor device identifiers to determine the sensor device from which the information originated. This determination may drive a decision as to how the server processes the information provided by the sensor device. For example, if the server is able to successfully identify and authenticate the sensor device, the server may store the payload portion provided by the sensor device in a data store, so that this data may be analyzed. If the server is not able to identify the sensor device, it may discard the data or store it in a separate data store.

In some embodiments, information may be communicated between network nodes in a secure manner, such that any of numerous communications protocols may be employed without jeopardizing the privacy of the information. For example, more than one level of encryption may be employed to provide secure data transport. Information transmitted by a sensor device may, for instance, be encrypted at multiple levels, and the client component may be given one level of clearance to decrypt certain components of the information (e.g., the identifying portion described above), while other components (e.g., the payload) remains secure. Upon identifying the sensor device and accepting information therefrom, the client component may further encrypt the payload (i.e., in addition to the encryption performed by the sensor device) for transport to the system server. When the system server receives the information, it may decrypt it to the extent needed to determine the identifying portion to determine if the sensor device is registered in the global registry, and if so, the system server may further decrypt the data for storage (e.g., in a database). Further, access to stored information may be facilitated via a secure access mechanism. For example, access to the information may be provided to the application server via a virtual private network.

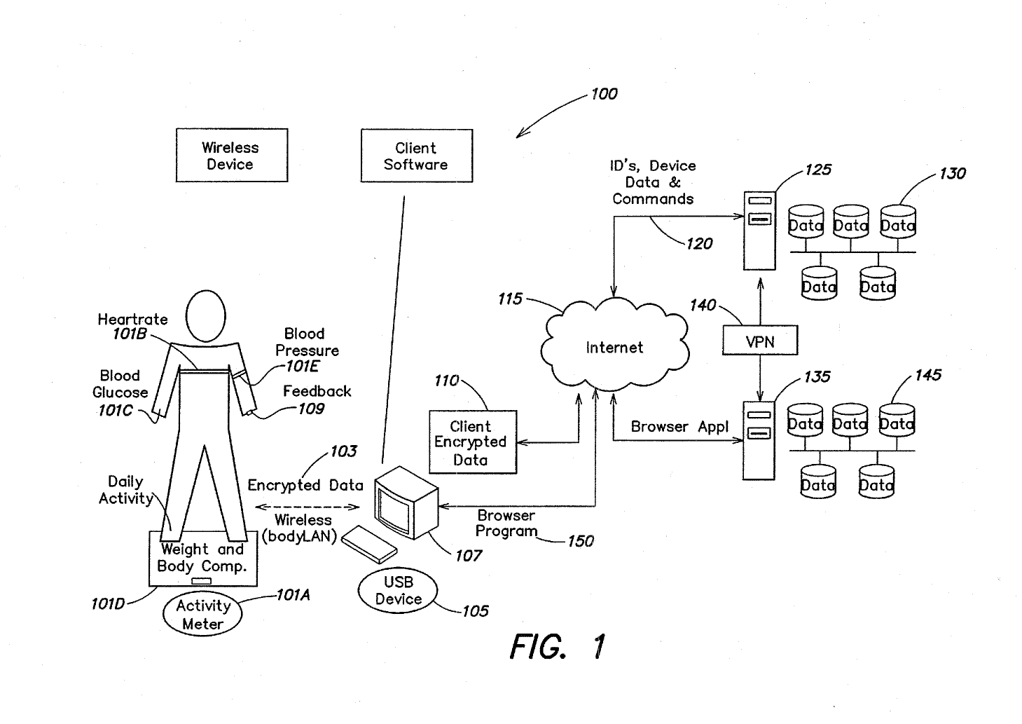

FIG. 1 provides a high-level overview of the manner in which information is communicated between nodes in accordance with one embodiment of the invention. In system 100, any of various devices 101 may be worn on a subject (e.g., a human subject) and may gather information relating to the subject. The information, or a derivation thereof, is transmitted wirelessly via connection 103 to computer 107, which comprises a client component and a link 105.

As shown in FIG. 1, sensor device 101 may take any of numerous forms, including activity meter 101A, heart rate monitor 101B, blood glucose monitor 101C, and/or blood pressure monitor 101E. As can be seen by body composition monitor 101D, a sensor device need not be worn by a subject, and may instead be implemented in another device such as a scale.

In addition to transmitting information to computer 107, any of sensor devices 101 may transmit information to a hand-held device 109, which may provide, for example, motivational feedback or store information provided by sensor devices 101 over time.

In the embodiment of FIG. 1, ActiLink USB device 105 is installed on computer 107 via, for example, a USB port thereon. Device 105 may, for example, comprise components which enables communication with sensor devices 101, and may store one or more application programs which may be executed on computer 107. Computer 107 may comprise a personal computer, kiosk, or any other suitable computing device, as the invention is not limited to a particular implementation.

In the embodiment shown, information provided by sensor devices 101 is received by link 105, processed by the client component (not shown) executing on computer 107, and forwarded to system server (“FitSense Data Servers”) 125. The information may be sent via Secure Internet Data Transport 115, although any suitable communications infrastructure and/or protocol may be employed. Upon arrival at server 125, the information may be partially or totally decrypted, such as to authenticate the sensor device. Upon authentication, the information may be stored in one or more of data stores 130. When the information is stored, server 125 may notify application server (“FitSense/provider Application Servers”) 135, which may then access the information in data stores 130. In the embodiment shown, access occurs via a virtual private network (VPN) 140, although any suitable mechanism, whether secure or insecure, may be employed. Application server 135 may, for example, execute programs which produce reports and otherwise analyze information stored in data store 130. Application server 135 may store the results of this analysis, and other information, in one or more data stores 145.

Computer 107 may also access information stored in data stores 130 and 145 via browser program 150, which communicates with data stores 130 and 145 via Internet 115. Of course, neither a browser program nor the Internet is required, as information may be accessed in any suitable manner. Providing access to the information stored in data stores 130 and 145 may allow the subject to view information provided by devices 101. For example, the information may be presented in a manner which encourages a healthy lifestyle and provides motivational feedback to the subject.

Embodiments of the invention may be employed to more efficiently gather, store and analyze health-related information, such as information provided by various sensor devices (e.g., an activity monitor, blood glucose monitor, heart rate monitor, blood pressure monitor, and/or a weight and body composition monitor) worn by a human subject. For example, in some embodiments, the information may be transmitted seamlessly, unobtrusively, and securely from one or more sensor devices to a client component, which may package and forwards the information to a server for storage. The information may be accessed by the subject or by others, and analyzed in isolation or in combination with other information, such as information provided by an insurer and/or employer of the subject. As a result of this analysis, the subject, insurer and/or employer may receive information related to the health of the subject in near real time, enabling more meaningful and timely analysis and/or feedback.

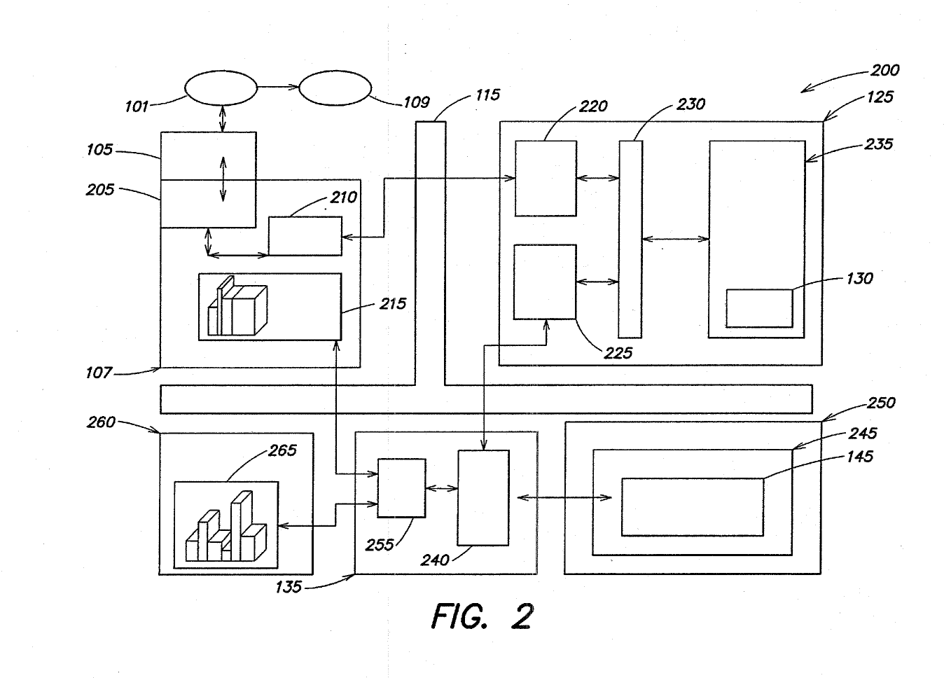

FIG. 2 depicts an exemplary implementation of a system for providing information collected by sensor devices to a data store accessible to a health provider network. In the implementation shown, ActiPed 101 is a foot-worn device which tracks the steps, activity, calories expended and distance traveled by a subject. In one embodiment, the ActiPed is a sensor device produced by FitSense Technologies, Inc., of Marlborough, Mass.

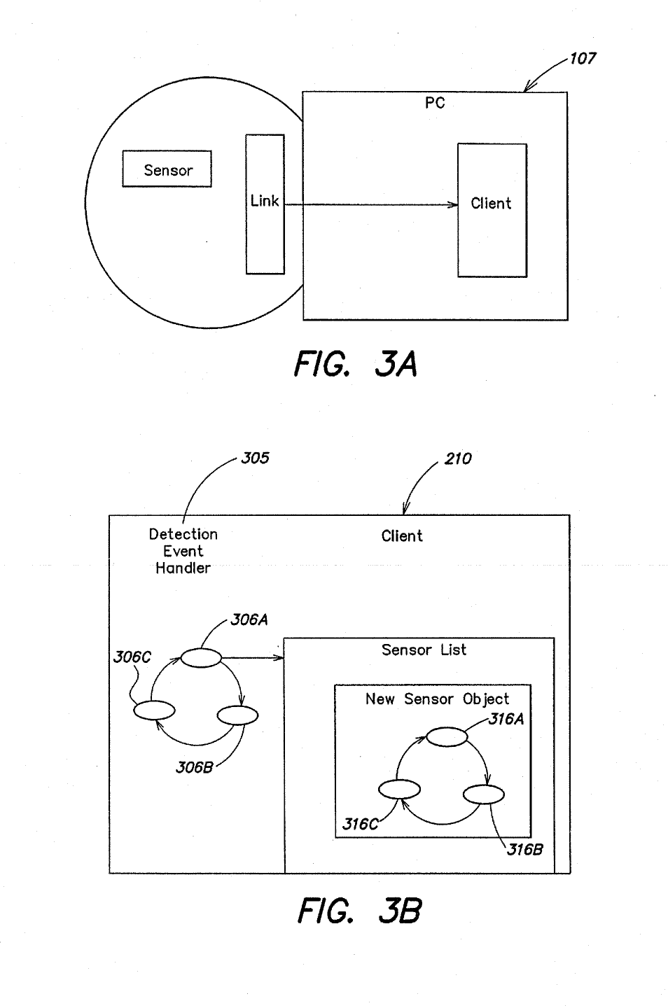

ActiPed 101 may provide information to ActiLink 105, which in the embodiment shown is a USB device providing a two-way communications interface between host PC 107 and ActiPed 101 via an integrated radio frequency (RF). ActiLink 105 may communicate with PC 107 via HID 205 and provide information to ActiHealth client 210, which may be an application program executing on PC 107. ActiHealth client 210 may then process the information (e.g., to identify the sensor device, as described above). This processing is described in further detail with reference to FIGS. 3, 4 and 5 below.

ActiHealth client 210 may transmit the information, or a derivation (e.g., further encrypted version), to ActiHealth client interface 220, executing on ActiHealth server 125, via internet 115. As described above with reference to FIG. 1, information sent by ActiHealth client 210 may be encrypted for transport and decrypted upon receipt by ActiHealth client interface 220. For example, the information may be decrypted to determine the sensor device identifier to determine whether information provided by the sensor device via ActiHealth client 210 should be stored on the ActiHealth server 125.

Upon authenticating the sensor device identifier, ActiHealth client interface 220 may cause information to be stored in sensor database 130. Specifically, ActiHealth client interface 220 may transmit the information to Microsoft SQL server 235 via web server 230, so that the information may be stored in sensor database 130.

In the depicted embodiment ActiHealth provider interface 225 notifies web server 240 executing on health provider server via internet 115 that the information has been stored in sensor database 130. Thereafter, health provider server A 135 may access the information stored in sensor database 130 via ActiHealth provider interface 225 and web server 230, such as to extract information stored in sensor database 130 for further processing. For example, information may be extracted for analysis, and may thereafter be stored in provider database 145 on health provider server B 250.

Web interface 255 provides access to information provided by sensor devices 101 stored in sensor database 130 and provider database 145. In the exemplary implementation shown in FIG. 2, this access is provided to a browser 215 executing on computer 107 and a browser 265 executing on health provider PC 260. Because web interface 255 communicates with information stored on both ActiHealth server 125 and health provider server B 250, it may provide information from both sensor database 130 and provider database 145 to either of browser 215 and browser 265.

In a variation on the system architecture shown in FIG. 2, subscriber PC 107 may be replaced by a kiosk. In general, a kiosk is a structure designed to provide access to information and services, which presents users with a simple, friendly interface. A kiosk may, for example, be specialized to a particular function (e.g., providing a touchscreen as with an ATM), unlike the generalized interface presented by a PC (e.g., the Microsoft Windows operating system).

One exemplary mode of interaction between components shown in FIG. 2 is described in further detail in Appendix A of Application Ser. Nos. 60/795,763 and 60/813,846, incorporated by reference above. However, it should be appreciated that the invention is not limited to the particular implementation described in Appendix A, and may be implemented in any suitable manner.

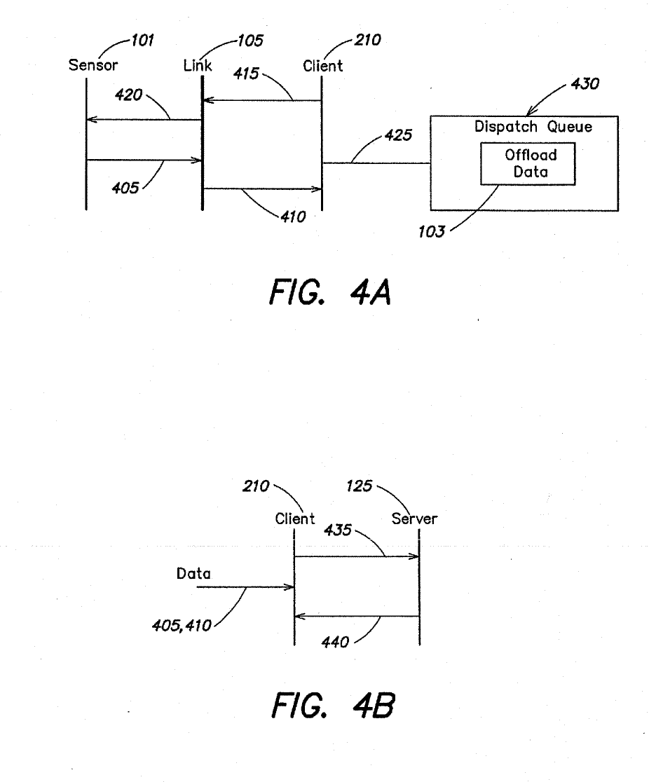

FIGS. 3 and 4 depict the interaction between sensor device 101 and the client component (comprising link 105, ActiHealth client 210 and PC 107) in greater detail. In the embodiment depicted, when sensor 101 moves within a range such that link 105 may detect its presence, link 105 transmits a notification 301 asynchronously (e.g., in real time) to ActiHealth client 210.

In some embodiments, ActiHealth client may comprise an event-driven state machine. The asynchronous notification 301 represents an event to ActiHealth client 210 which may be processed by detection event handler 305. When the notification is received, ActiHealth client 210 may instantiate a new sensor object 315, with the object 315 having states 316A-316C. Any number of sensor objects may be maintained in sensor list 310.

In some embodiments, upon detecting that sensor 101 has moved outside its detection range, link 105 may send another notification to ActiHealth client 210 to provide notification that communication with the sensor has been lost. When this notification is received, detection event handler 305 may change the state of the sensor 306 to disabled, and remove sensor object 315 from sensor list 310.

FIG. 4 depicts how data captured by sensor device 101 may be transmitted from the sensor to ActiHealth client 210. When the sensor 101 moves within detection range of the link 105, a communication 405 is completed between the sensor and the link, and the notification 410 is sent from link 105 to client 210. After processing the notification to create a new sensor object 315 in sensor list 310, client 210 then sends a notification 415 to link 105, which passes the communication back to sensor 101 in notification 420. Thereafter, the sensor may attempt to offload data stored thereon to link 105. This may, for example, occur as a series of transactions between sensor 101, link 105 and client 210. In some embodiments, if this offload is successful, the information provided by sensor 101 may be packaged (e.g., into a data structure) and placed in a queue to be dispatched to a remote device (FitSense data server 125, FIG. 1).

In some embodiments, ActiHealth client 210 may comprise a dispatcher which processes data packages in the dispatch queue by constantly monitoring the queue for new entries. When an entry is detected in the queue, a series of transactions may be processed between the client 210 and the remote device to immediately remove the data off of the client to the remote device in notification 435. In some embodiments, the remote device 125 may acknowledge receipt of the information with notification 440 sent to client 210.

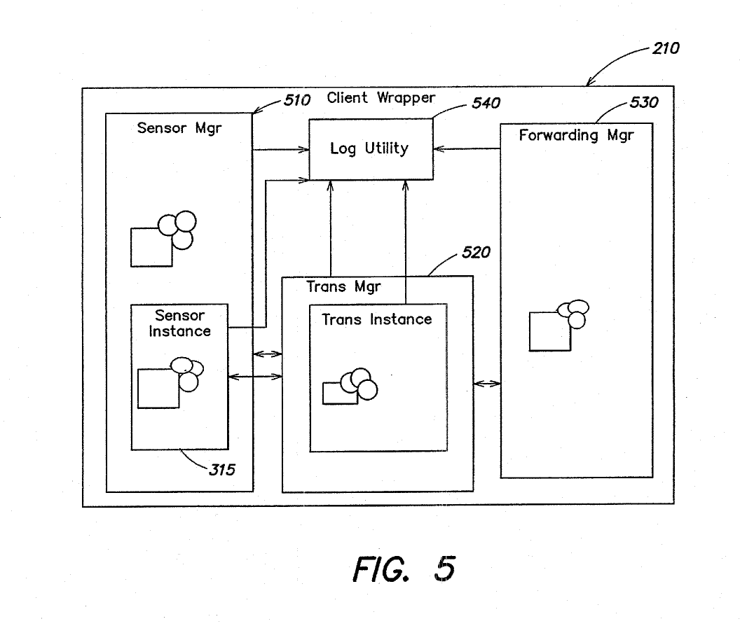

FIG. 5 depicts the modules that may be provided by client component 210 in greater detail. Overall, client component 210 may instantiate the modules shown in FIG. 5 and integrate with applicable operating system hooks. It may retrieve information (e.g., activity data) from sensor devices, and write the information to a directory on a local file system on the computer on which client component 210 executes. The forwarding manager may read the information from the local file system and transmit it to the server.

Sensor manager 510 may maintain the sensor list 310 described above with reference to FIG. 4, instantiate sensor objects when a particular sensor moves within detection range, and eliminate sensor instance objects when a sensor moves outside the detection range.

Sensor instance 315 may be managed by sensor manager 510 and provide transaction sequencing semantics for sensor interoperability. In some embodiments, the sensor instance may be maintained as a state machine, such that the sensor instance may be transitioned to a state of enabled when the sensor moves within the detection range of the link, and can be transitioned to a disabled state when the sensor moves outside the detection range.

Transaction manager 520 may manage a list of transactions. For example, the transaction manager 520 may coordinate a series of transactions instances 525 which provide message semantics for client-to-server operations, client-to-link operations, and client-to-sensor operations. In some embodiments, a base transaction object may support common operations.

Forwarding manager 530 may retrieve a set of activity data from the queue directory and forward it to server 125. In some embodiments, upon detecting that a transaction has been loaded to the queue, the forwarding manager 530 may read the information and forward it to server 125 via a client-to-server operation. The forwarding manager may also be configured to determine whether a connection to internet 115 is active or disabled.

Log utility 540 may provide a framework for logging actions taken by client 210 which may be used, for example, to debug client 210. In some embodiments, each log record may consist of a common header and contain a set of fields which are specific to exception handling, transaction processing or state changes.

More information relating an exemplary implementation of client component 210 is provided in Appendix B of Application Ser. Nos. 60/795,763 and 60/813,846, which are incorporated by reference above, However, it should be appreciated that the invention is not limited to the implementation described in Appendix B, and may be implemented in any suitable manner.

In some embodiments, communication between sensor 101 and link 105 may be accomplished in a manner which allows for the unique identification of devices in the network. For example, the protocol may allow for devices 101 to be identified using a combination of their device type (e.g., specified by the manufacturer) and address. In some embodiments, a host and sensor may form associations in connections using these two values to ensure an exclusive connection which may help to ensure data integrity and security, such that the information isn't snooped by or lost to another host.

More information relating to communication between sensor devices, one or more clients, and servers is provided in Appendix C of Application Ser. Nos. 60/795,763 and 60/813,846, which are incorporated by reference above.

Another system architecture for providing functionality described herein is disclosed in Appendix D of Application Ser. Nos. 60/795,763 and 60/813,846.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A communication method for use in a system comprising a plurality of sensor devices, a link component, a server component, and at least one network coupling the plurality of sensor devices, the link component and the server component, the method comprising acts of:
(A) receiving, by the link component, first data sent by a sensor device;
(B) sending, via the at least one network, second data to the server component, the second data comprising at least a portion of the first data;
(C) determining, by the server component, whether the sensor device can be identified as one of the plurality of sensor devices based at least in part on an analysis of the second data; and
(D) processing, by the server component; the second data in a manner which depends on the determination in the act (C).

2. The communication method of claim 1, wherein the first data is collected by the sensor device.

3. The communication method of claim 1, wherein at least a portion of the first data relates to activity by and/or health of a human subject associated with the sensor device.

4. The communication method of claim 3, wherein the first data comprises a payload portion which relates to activity by and/or health of the human subject, and an identifying portion which identifies the sensor device.

5. The communication method of claim 1, wherein the act (B) is performed by the link component or a client component in communication with the link component.

6. The communication method of claim 1, wherein the second data comprises one or more of a derivation of at least a portion of the first data, and an encrypted version of at least a portion of the first data.

7. The communication method of claim 1, wherein the act (C) comprises the server component authenticating the sensor device.

8. The communication method of claim 1, wherein the act (C) comprises comparing at least a portion of the second data to a registry comprising identifiers for the plurality of sensor devices.

9. The communication method of claim 1, wherein the act (B) comprises the link component or a client component in communication with the link component identifying the sensor device based at least in part on the first data.

10. The communication method of claim 1, wherein the act (D) comprises the server component:
storing at least a portion of the second data in a first data store if it is determined in the act (C) that the sensor device can be identified as one of the plurality of sensor devices; and
discarding the second data or storing at least a portion of the second data in a second data store if it is determined in the act (C) that the sensor device can not be identified as one of the plurality of sensor devices.

11. A system, comprising:
a link component, comprising at least one communications interface configured to receive first data sent by a first sensor device, and to send second data via at least one network, the second data comprising at least a portion of the first data; and
a server component, comprising:
at least one communications interface configured to receive the second data sent via the at least one network; and
at least one processor programmed to determine, based at least in part on an analysis of the second data, whether the first sensor device can be identified as a valid sensor device, and to process the second data in a manner which depends on the determination.

12. The system of claim 11, further comprising a plurality of sensor devices, wherein the at least one processor of the server component is programmed to determine whether the first sensor device can be identified as a valid sensor device based at least in part on whether the first sensor device is one of the plurality of sensor devices.

13. The system of claim 11, wherein the at least one processor of the server component is programmed to determine whether the first sensor device is one of the plurality of sensor devices by comparing at least a portion of the second data to a registry comprising identifiers for the plurality of sensor devices.

14. The system of claim 11, wherein the first data is collected by the first sensor device.

15. The system of claim 11, wherein at least a portion of the first data relates to activity by and/or health of a human subject associated with the first sensor device.

16. The system of claim 15, wherein the first data comprises a payload portion which relates to activity by and/or health of the human subject, and an identifying portion which identifies the first sensor device.

17. The system of claim 11, wherein the second data comprises one or more of a derivation of at least a portion of the first data, and an encrypted version of at least a portion of the first data.

18. The system of claim 11, wherein the at least one processor of the server component is programmed to authenticate the first sensor device.

19. The system of claim 11, wherein the link component comprises at least one processor programmed to identify the first sensor device based at least in part on the first data.

20. The system of claim 11, wherein the at least one processor of the server component is programmed to store at least a portion of the second data in a first data store if it is determined that the first sensor device can be identified as a valid sensor device, and to discard the second data or to store at least a portion of the second data in a second data store if it is determined that the first sensor device can not be identified as a valid sensor device.
